(19) United States
(12) Patent Application Publication
(10) Pub. No.: US 2008/0209836 A1
(43) Pub. Date: Sep. 4, 2008

(54) Contained Load Transfer Device for Wood Sheathing Products and Roof Construction Method Therewith

(75) Inventors: John Landus Bennett, Nicholson, GA (US); Vincent B. Thomas, Athens, GA (US); Richard D. Jordan, Lawrenceville, GA (US)

Correspondence Address: J M HUBER CORPORATION, 333 THORNALL STREET, PATENT DEPARTMENT, EDISON, NJ, 08837-2220, US

(73) Assignee: HUBER ENGINEERED WOODS LLC, Charlotte, NC (US)

(21) Appl. No.: 12/014,008

(22) Filed: Jan. 14, 2008

Related U.S. Application Data
(63) Continuation-in-part of application No. 11/403,631, filed on Apr. 13, 2006, now abandoned.

(51) Int. Cl. E04B 1/38; F16B 5/12

(52) U.S. Cl. 52/586.1; 403/408.1

(57) ABSTRACT

A load transfer device (LTD) allowing for reliable connection and linkage of composite wood boards is provided. A LTD is configured for containment within openings within peripheral edges of wood boards which are cut into a complementary shape to that of the device. The device, when assembled in panel openings, permits separation of adjacent boards, as well as, sufficient load bearing strength for the overall construction within which such connected wood boards are utilized. The separation of wood boards permits proper sealing therebetween and proper distance for shrinking or swelling during the lifetime of the edifice. The ability to impart increased load bearing strength allows for an increase in construction materials to be carried and kept on such a structure during construction. The method of manufacture of a structure utilizing load transfer devices between boards is also disclosed.

### CROSS-REFERENCE TO RELATED APPLICATIONS

This application is a continuation-in-part of U.S. patent application Ser. No. 11/403,631, filed Apr. 13, 2006, co-pending.

### FIELD OF THE INVENTION

The invention relates to a specific load transfer device (LTD) and utilization of the device for the purpose of allowing for reliable connection and linkage of composite wood boards during construction therewith. Such a device is configured for containment within an opening in a peripheral edge of such wood boards, and the opening has a shape that is complementary to that of the device. A device, when introduced within a properly shaped opening, permits separation of adjacent wood boards that are applied to the frame of an edifice, as well as, ultimately, sufficient load bearing strength for the overall construction (such as a roof) within which such connected wood boards are utilized. The separation of wood boards, thus, permits proper sealing therebetween (with tape, sealant, or other like material) as well as proper distance for shrinking or swelling (due to, e.g., temperature/moisture variations) during the lifetime of the edifice (thereby permitting expansion as needed). The ability to impart increased load bearing strength, thus, allows for an increase in construction materials (in number and in weight) to be carried and kept on such a structure during construction as well. The method of manufacture of an edifice utilizing such load transfer devices between wood boards is also encompassed within this invention.

### BACKGROUND OF THE INVENTION

Composite wood boards, such as plywood boards or oriented strand boards, are well-known in the construction industry. Composite boards are used in the manufacture of inclined roofs. To facilitate making the roofs, board manufacturers sell rectangular boards which are about four feet wide, eight feet long, and about ⅜ to ¾ of an inch thick. Such boards are generally not attached to a roofing frame with adjacent boards abutting another, but, instead, adjacent boards are supposed to be spaced slightly apart from each other. Spacing is required to compensate for expansion possibilities due to, e.g., temperature and moisture changes during the lifetime of the roof. There is needed a manner of providing insulation between the spaces of such roof component boards. This is typically accomplished with insulating tape, or any other like material. The tape is often applied to ends of adjacent boards and across such spaces.

Also desirable for such roof structures and, thus, the component boards themselves, is the capacity to withstand excessive weight due to the loads of workers present on the roof during construction as well as the materials applied during such a construction project (and, furthermore, the combined weight of a worker carrying such materials on said roof). Additionally, there is a need to ensure that the boards that constitute the roof structure can stay in place for sufficient time to be permanently attached to the underlying roofing frame.

In order to address these needs, there have been utilized certain devices in the form of clips that contact the outside edges of adjacent boards (on both the top and bottom thereof). Such clips, known in the industry as H-clips, exhibit disadvantages, however, that render them highly undesirable. For instance, H-clips make it difficult to apply adhesive tape (for, e.g., sealing seams to prevent water penetration therein and air leaks) along the spaces between boards conjoined by such clips, particularly since such clips are applied to the exterior of such boards. The adhesive tape applied to boards attached with H-clips must, therefore, be in contact with the clips as well as the boards, thereby exhibiting a certain reduction in potential adherence and compromising the effectiveness of tape (or like adhesive material). Also, it has been problematic to apply certain load forces to roof structures including H-clips, particularly during construction, as clips exhibit a propensity for disengaging upon application of excessive weight on certain portions of the boards. As such, there exists a need and desire to replace utilization of H-clips while still providing a viable manner of permitting effective connection between adjacent boards during roof construction, and while simultaneously allowing for application of materials via adhesion to adjacent boards without losing the effectiveness of the adhesive materials. To date, the wood board roofing component industry has not been accorded such an improvement.

### SUMMARY

It is an advantage of the present invention to provide a simple manner of reliably connecting/linking wood boards together during construction, e.g., roof construction. Another advantage of such a device and method is the ability of a user to easily install such devices within target wood boards and, further, connect an adjacent wood board thereto through the utilization of at least one such device in order to keep such wood boards in place for a sufficient period of time prior to attachment to a roof frame.

The invention includes a load transfer device (LTD) for achieving linking of adjacent boards. The device can comprise two faces and at least one edge with an overall essentially symmetrically shape which comprises a material with an MOE of about 10,000,000 psi or less wherein a first dimension is less than a length of an edge of a panel wherein a second dimension is effective to hold the device within openings within edges of adjacent panels while providing a pre-determined gap between panels when panels and devices are assembled and wherein a third dimension is less than a thickness of a panel and wherein the device is capable of meeting PS-2 requirements when assembled within panels and not breaking shoulders of adjacent panels when under load.

The invention also includes a structure comprising at least two adjacent boards and at least one load transfer device of the invention wherein the load transfer device is inserted within openings of the two boards located within the periphery of the boards and wherein the load transfer device creates a pre-determined gap between the boards' peripheries. The invention includes a structure for an edifice selected from the group consisting of a roof and a wall, wherein the structure is comprised of at least a first wood board and a second wood board, each wood board having a top surface, a bottom surface and four peripheral edges, wherein at least one peripheral edge of each wood board includes at least one opening therein for the insertion of at least one load transfer device; wherein the load transfer device is made of a durable material and having a first side and a second side and wherein each of said first and second side is configured to be inserted within the at least one opening of each wood board; wherein when said first and second wood boards are contacted simultaneously with said device, said peripheral edges into which said device is inserted are essentially parallel to each other, but are not in contact with one another, and wherein the device does not contact the top or bottom surface of said first and second wood boards. Further, s roof or wall structure of the invention can further comprise limitations such as: wherein said first end and said second side are shaped exactly the same and of the same dimensions, wherein said device is configured in such a manner that either of said first or second side can be placed within said at least one opening within said peripheral edge of said first wood board, said opening exhibiting a shape and dimension that is complementary to said first or second side of said device, and wherein when present within said opening of said first wood board, said second wood board can then be contacted with said second side of said device in relation to the same type of opening as defined for said first wood board within said peripheral edge of said second wood board.

A method of manufacturing a roof in accordance with such a scheme and utilizing at least two such wood boards and at least one LTD for such a purpose is encompassed within this invention as well.

A load transfer device of the invention is preferably symmetrical in shape and measurements in order to exhibit the ability to be inserted within cavities (openings) of any wood board used therewith. The size of a LTD can be of any length, up to the length of the peripheral edge of the target wood board(s) less an inch and a half (i.e., about 3.8 centimeters), generally. As the distance of typical spacing between roof joists for roof construction wood boards are about 24 inches on center (i.e., about 61 centimeters), such a device can be as long as 22.5 inches (roughly about 57 centimeters). At its smallest, such a device would be about 1 inch (2.54 centimeters) long. Preferably, though not necessarily, multiple devices would be utilized to connect adjacent boards together during the construction of a structure, mainly because of the facilitation of maneuverability a user would have with smaller devices in hand during construction, rather than large devices for such a purpose.

The device can be incorporated within a roll containing a release liner with an adhesive attaching multiples of the LTDs to the liner from which they can be peeled and applied within the cavities of wood boards, potentially with the adhesive transferred therewith to permit reliable attachment of such devices to target wood boards. A roll of LTDs would allow a user to have a relatively convenient and safe manner of not only transporting multiple devices, but also applying an adhesive-including LTD within a target wood board.

Using an adhesive is also desirable if the device(s) are transported by a user by different means. An adhesive can be applied by a user by hand prior to utilization, or such devices can have covering strips over an already-applied adhesive area thereon, from which the strip can be removed by the user prior to utilization and insertion within a wood board opening. Any other manner of adhesive application can also be followed for such a purpose.

The LTD itself can be constructed of any durable material, and of any shape and dimension, as long as the overall appearance is, as noted above, symmetrical. Thus, plastics (including high density plastics like polyurethane, polyethylene, polypropylene, polyethylene terephthalate, polyacrylate, polyacetyl, and the like), metals (including iron, steel, aluminum, and the like), and any type of hardwood (oak, cedar, and the like), can be utilized. Combinations of such materials (such as mixtures of different plastics, a plastic coated metal or wood, and the like) can also be utilized.

A LTD having an increased surface area through texturing, roughening, and the like, over the faces or edges or both thereof, can also be employed, particularly if an adhesive is utilized in conjunction therewith. Such an increase in surface area can contribute an increase in adhesive force during utilization and possibly strengthen the joint (like a truss plate, for example).

As noted above, it was important to provide a manner of connecting adjacent wood boards together wherein such boards do not contact one another during installation. This distance can be from about 1/16 inch to about ¼ inch, generally, and, thus, would require the depth of the cavities present within the wood boards to equal less than one-half the overall width of a single LTD. Building codes of various jurisdictions have varying requirements in terms of board spacing, but a popular distance is ⅛ inch for the gap between adjoining edges (to allow for expansion and contraction of the panels due to, e.g., moisture and/or temperature variations). This can be accomplished by providing a LTD of sufficient width that upon insertion within the cavities of adjoining boards, the gap is substantially uniform and cannot be breached. Alternatively, the LTD can be produced with a post in the center thereof to provide such spacing upon utilization.

As the opening should preferably be complementary in shape and dimension to the LTD, any such shape or dimension can be employed for the LTD and wood board opening as long as they meet such requirements. Thus, if the LTD is an oval-shaped disk, the cavity will likewise exhibit a complementary oval indentation of roughly the same measurements. If the device is a rectangular disk, again, the cavity (slot) will be formed to accept such a shape and measurements. In one particularly preferred embodiment, the LTD can include a pin at the middle thereof to aid in distancing the adjacent wood boards from one another. Furthermore, the cavity (slot) can also include a flared portion (or post portion, as noted above) to facilitate insertion of such a LTD therein and further facilitate the insertion of the other end of such a device within the cavity of a second wood board during construction.

Additionally, and as noted above, the need to permit reliable application of tape thereto necessitated development of a device that would not have any contact with both the top and bottom of a wood board during utilization. Thus, the overall method would permit insertion of such a device, or plurality of devices, within at least two wood boards simultaneously without any contact between the two wood boards, but with them residing in parallel relation to one another, and without any contact between the device, or plurality of devices, and the top and bottom portion of either wood board connected thereto.

Such a method provides more than just a manner of connecting roof or wall component wood boards prior to attachment to a roofing or wall frame, as well as more than just a manner of permitting tape to be reliably adhered to the subject wood boards in the areas in which they are not in contact with one another. In addition to those highly desirable results, it was surprisingly realized that such a method imparts a heretofore unforeseen ability to withstand larger than usual load forces associated with the weight of a construction worker and the materials such a person would normally be required to transport over a roof during construction thereof. Such load bearing results are discussed in greater detail below.

The wood boards that can be utilized for such roof construction can be of any type, including oriented strand board, plywood, and the like.

### BRIEF DESCRIPTION OF THE DRAWINGS

The above-mentioned and other aspects of invention will become apparent by reference to the following description in conjunction with the accompanying drawings. The drawings are not drawn to proportion. Like numbers represent the same elements throughout the figures.

FIG. 1 is a top view of a roof with panels placed on center of the underlying framing studs.

FIG. 2 is a top view and a side view of an oval-shaped LTD.

FIG. 3 is a side view of a LTD exhibiting an increased surface area.

FIG. 4 is a top view of a two adjacent panels before they are joined by an LTD with the LTD placed in an opening in the periphery of one of the panels. The cross-section shows two alternatives for the opening-one which is complementary to the LTD and one which is complementary to the LTD but has flares for ease of insertion of the LTD.

FIG. 5 is a cross-sectional view of a LTD having a pin present at its midpoint and inserted within the cavities of two wood boards.

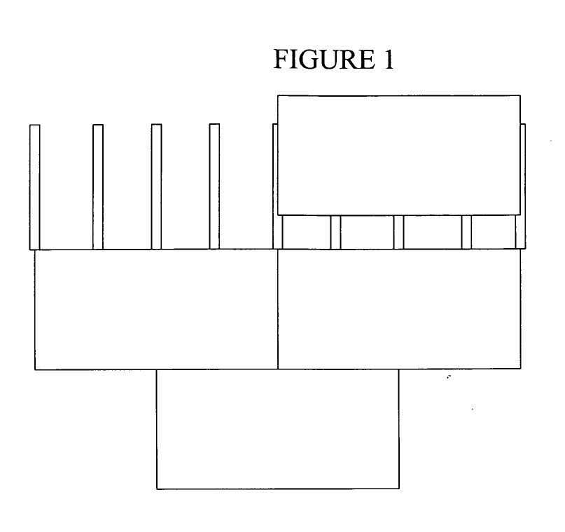

### DESCRIPTION OF A PREFERRED EMBODIMENT

Before the present articles, devices, and/or methods are disclosed and described, it is to be understood that the aspects described below are not limited to specific embodiments, specific embodiments as such may, of course, vary. It is also to be understood that the terminology used herein is for the purpose of describing particular aspects only and is not intended to be limiting.

In this specification and in the claims which follow, reference will be made to a number of terms which shall be defined to have the following meanings:

It must be noted that, as used in the specification and the appended claims, the singular forms “a,” “an,” and “the” include plural referents unless the context clearly dictates otherwise. Thus, for example, reference to “an acetyl polymer” includes mixtures of acetyl polymers; reference to “a metal” includes mixtures of two or more metals, and the like.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

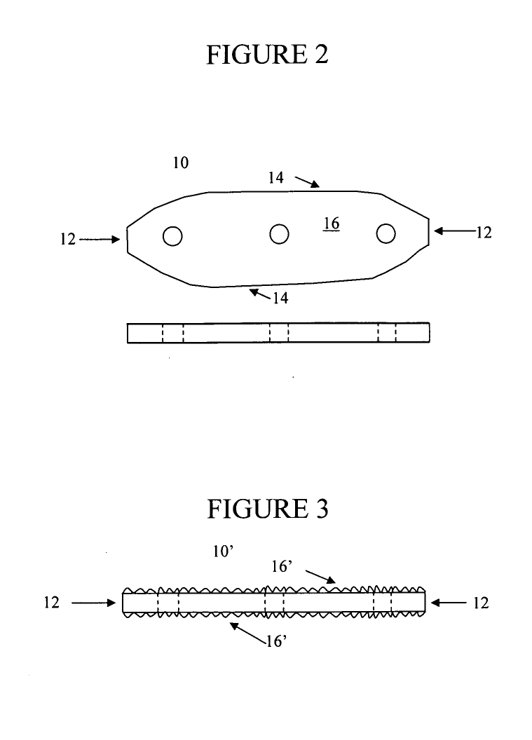

FIG. 2 shows a top and side view of an example embodiment of a roughly oval shaped LTD 10. This LTD has two ends 12, two sides 14, and two faces 16 (one not shown). FIG. 3 shows an alternative embodiment where the LTD has a roughened rather than smooth surface. The LTD 10′ of FIG. 3 merely show that such devices, regardless of shape, can be modified or produced originally in such a manner as to impart an increase in surface area to the faces 16′ to aid such devices in remaining snugly within the openings in which they are inserted within wood boards (not illustrated).

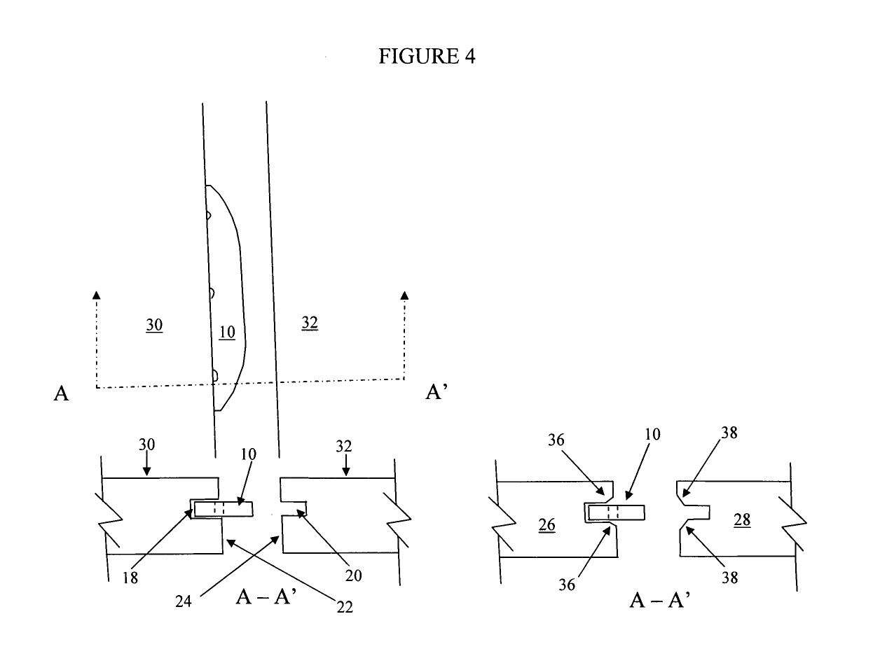

FIG. 4 shows a top view and cross-sectional views of a LTD 10 inserted within opening 18 of peripheral edge 22 of two adjacent wood boards 26, 28. The corresponding opening 20 is in the peripheral edge 24 of board 28. As can be seen, the LTD 10 fits snugly within the openings 18, 20 and creates a pre-determined gap (e.g., approx. ⅛″) between the boards 26, 28 when assembled (not shown). A tape (not illustrated) can then be applied in contact with the top portions 30, 32 of both wood boards 26, 28 over the gap. When multiple LTDs 10 are utilized at various locations along the edges 22, 24, the distance between the wood boards 26, 28, will be roughly uniform along the peripheral edges 22, 24. As shown in the right cross-sectional view, the openings can have flares 36, 38 which can facilitate insertion of an LTD 10.

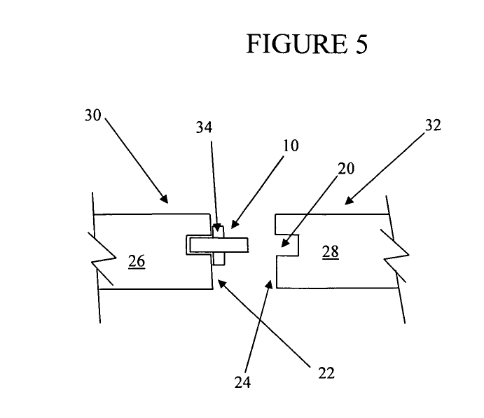

FIG. 5 depicts a cross-sectional perspective of a different example embodiment wherein the LTD 10 includes a pin 34 at its midpoint to aid in keeping the distance (gap) between the boards 26, 28 uniform and in parallel relation thereto. If such boards 26, 28 are not kept parallel to one another, the skewed result could deleteriously affect the spacing of other portions of the target roof. Also, the flared portions 36, 38 of the wood boards 26, 28 allow for insertion of an LTD 10 having portions (not shown) near the midpoint that complement the shape of such flares 36, 38, thereby facilitating insertion of the disk 10 within the cavities 18, 20 within the peripheral edges 22, 24 of the wood boards 26, 28 as well as permitting a firm and snug fit of the LTD 10 therein during use.

To insure that a load transfer device of this invention is capable of providing the necessary load capacity, concentrated load testing was done comparing a load transfer device of this invention to current load transfer devices (“H”-clips) used today in the construction industry. Building codes and regulations generally require that sheathing with a span rating of Roof—24 must not exceed 0.5″ of deflection under a 200 pound load. Previous testing conducted using H-clips revealed that the H-clip would fall from the specimen prior to the completion of the test. Sampling of the inventive load bearing/transfer device (LTD) indicated that it would break the shoulder (the portion of the board that surrounds the opening into which the LTD, biscuit, clip, or other device, is inserted during utilization thereof) either above or below the area where it was placed; however, the specimen would still pass the requirement set forth by the aforementioned building codes and regulations (known in the industry as PS-2). The inventive load transfer device in a manner, thus, maintains its integrity upon use in such a manner (i.e., the LTD would remain in place when a concentrated load was applied at its location).

The opening in the target wood board edge can be configured as well in any shape, particularly at the entry point, in order to facilitate ingress of the LTD itself. Thus, the edge of the point of entry can be curved, tapered, or any like effect, to permit such ease in application. This can be important to facilitate such application especially while a user has a number of tools and other implements in his/her hands.

It is accepted that the highest concentrated loads on roof sheathing are anticipated under foot traffic during construction. For example, a 200-lb man carrying an 80-lb bundle of shingles down a roof slope can exert a load up to 68% greater than his combined total weight (Harper, F. C., et al. 1961. The Forces Applied to the Floor by the Foot in Walking. Research Paper 32. National Building Studies, London, England). Since the walking loads are applied for less than one second, the total load can be reduced by a load-duration factor of 1/1.22 for short-term tests, as follows:

$$\frac{( 200 + 80 ) ( 1.68 )}{1.22} = 386 lbs$$

The effective load is even less (up to 280 lbs) if the man stands in one location for a short period of time, and in addition, the load is distributed over a larger area by both feet.

In the light of the foregoing, a minimum load of 400 lb would give a small margin of safety, which is justified considering the uncertainties of construction. Therefore, it is desired that any load transfer device remain intact up to a 400 lb concentrated load.

Different inventive load transfer/bearing devices made from different materials and of various dimensions were produced and analyzed in order to determine the effectiveness of such devices to withstand such loads upon use. The materials in accordance with the design shown in FIG. 2, above, were as follows:

TABLE 1

Thickness

| | |
|---|---|
| ⅛″ | 1/16″ |

| | |
|---|---|
| Material | Length of LTD |

| | | |
|---|---|---|
| Wood | 1.75″ | |
| Steel | 2.2″-3.5″ | |
| Acetyl | | 2″-3.5″-4.5″ |
| High density polyethylene | | 2″-3.5″-4.5″ |
| Aluminum | | 2″-3.5″-4.5″ |

The modulus of elasticity of some of these materials was a parameter as well in determining their level of effectiveness. It was determined that the greater the elasticity, the better the LTD made therefrom was able to withstand load bearing weights to a greater degree. It is believed, without intending to be limited to any specific scientific theory, that such greater load bearing capability is provided in relation to the flexibility of the device and, thus, the capacity of such a material to simultaneously bear weight when applied directly to the area affected, as well as the area adjacent thereto. A material with very high stiffness appeared to force the device to break the shoulder portion of the board before the device itself was injured to any appreciable extent. A material with a much lower stiffness allowed more deflection of the device and joint under concentrated loads. Thus, although any of these materials will suffice within the invention as presented, preferably the device is a material exhibiting a MOE of 10,000,000 psi or below, more preferably lower than 1,000,000 psi, and most preferably from about 100,000 to about 500,000 psi. High density polyethylene exhibits a MOE of about 200,000 psi and polyacetal from about 305,000 to about 380,000 psi. Aluminum's MOE is as high as 10,000,000. This list is not exhaustive of the potential materials available for this device, but illustrative thereof.

The manner of measuring load bearing was undertaken as follows:

First, a comparison was conducted of how the below surface LTDs vs. H-clips performed under a concentrated load. To meet PS-2 requirements, the panel/LTD combo must:

a) not exceed 0.5″ deflection under a 200 pound concentrated load; and

b) exceed 400 pound ultimate load (such as under foot traffic, as described above).

Another functional product requirement that was deemed desirable, even if PS-2 requirements were met, is the ability of the entire panel(s) plus LTD not to exhibit any breaking of the shoulders at the placement area of the below surface LTD prior to reaching a 400 lb concentrated load.

The analysis performed to determine this desired level of effectiveness was an analysis of variance calculation. In essence, in order to avoid the possibility of having a person become injured during actual testing of a constructed roof or a roof being constructed, the subject structures were analyzed in a lab environment for deflection and load bearing capability. A TECO QL-2 Panel Performance Tester (TECO, Sun Prairie, WI; http://www.tecotested.com/test_machines_ql2.php) was utilized for such analysis. Such an instrument is a fully automated, computer-controlled machine designed to perform testing that is consistent with PS 2-92 concentrated static, impact load and deflection test requirements. The instrument is equipped with a “floating bed” that facilitates impact testing, as well as instrumentation to test for concentrated load and deflection, ultimate (failure) load, impact load, and edge-supported panels. The test panels were about 1 inch in thickness (the machine can test for thicknesses between ¼ and 1⅛ inches, and the length of subject panels (boards) can be from 16 to 48 inches. In the test, utilizing two boards connected via the inventive device, 48-inch boards were used. Generally, simulated joists (three in all) were included within the instrument to permit testing comparable to load bearing of roofing sheathing during installation of boards having dimensions of 48 inches (121.92 cm) by 96 inches (243.84 cm). A board was connected to the simulated joists and 4 LTD devices were then inserted within the cavities provided in the periphery of the board (the devices were about 8 inches in length and inserted widthwise, as shown in the Figures). A second board of the same dimensions and having complementary cavities therein for connection to the already inserted LTDs was then supplied. That board was then connected via the LTDs without contacting directly the first board. A floating panel bed was then moved into place beneath the two device-connected boards and pressures were then supplied to specific areas of the boards to measure load bearing and deflection thereof. A pneumatic pressure applicator was utilized and was applied hydraulically at two locations on the subject boards (in accordance with the PS 2-92 test requirements) and read by a 2,000 pound capacity load cell. A high-resolution digital encoder was utilized to record the deflection after the pressure (weight) was applied.

Upon application of the weight (pressures) tested, the measurements were taken as calculation by an analysis of variance (ANOVA) method. Such a method is similar to regression in that it is used to investigate and model the relationship between a response variable and one or more independent variables. However, analysis of variance differs from regression in two ways: the independent variables are qualitative (categorical), and no assumption is made about the nature of the relationship (that is, the model does not include coefficients for variables). In effect, analysis of variance extends the two-sample t-test for testing the equality of two population means to a more general null hypothesis of comparing the equality of more than two means, versus them not all being equal. A two-way analysis of variance tests the equality of populations means when classification of treatments is by two variables or factors.

It was assumed that the population means in each test was the same and computed a p-value for the sample means in order to determine the difference in the samples means. This method, thus, considers the likelihood that two sample means would be a certain distance apart if they come from two processes with the same mean. If the p-value is small, it was concluded that the population means were different (i.e., less than 0.5).

The abbreviations below are as follows:

DF=Degrees of Freedom. The extent to which the distribution was more spread out. As this measurement gets larger, the distribution dispersion gets smaller.

SS=Sum of Squares. This represents total variation of measurements.

MS=the MS error is the pooled standard deviation squared.

F=F test. Such a test answers the question if the two population variances are different. This test determines if the two populations exhibit similar or dissimilar factors and, thus, uses samples variances between the populations tested. This does not, however, actually test the degree of difference in sample variances, only if they exist. A value of greater than 4 for an F-value is significant whereas as close to 1 as possible means the group means of measurements are very similar between the two populations.

Thus, the analyses were followed as noted below:

TABLE 2
ANOVA showing deflection under a 200 lb concentrated
load using below surface LTDs and H-clips

| Source | DF | SS | MS | F | P |
|---|---|---|---|---|---|
| Material | 5 | 0.15101 | 0.03020 | 4.68 | 0.002 |
| Error | 35 | 0.22602 | 0.00646 | | |
| Total | 40 | 0.37703 | | | |

S = 0.08036 R-Sq = 40.05% R-Sq(adj) = 31.49%

| | | | | Individual 95% CIs For Mean Based on |
|---|---|---|---|---|
| | | | | Pooled StDev |
| Level | N | Mean | StDev | --------+---------+---------+---------+- |
| Acetyl | 6 | 0.25117 | 0.02522 | (-------*--------) |
| Aluminum | 6 | 0.24100 | 0.03013 | (-------*-------) |
| H-Clips | 10 | 0.38790 | 0.09954 | (-----*------) |
| HDPE | 6 | 0.28133 | 0.08078 | (-------*-------) |
| Steel | 9 | 0.36578 | 0.10176 | (------*------) |
| Wood | 4 | 0.37500 | 0.06746 | (---------*---------) |
| | | | | --------+---------+---------+---------+- |
| | | | | 0.240 0.320 0.400 0.480 |

Pooled StDev = 0.08036

Our initial testing indicated that acetyl and aluminum below surface LTDs were significantly better than H-clips in relation to deflection under a 200 lb concentrated load. The steel, wood and HDPE were not significantly different than H-clips.

Further testing was then performed to determine if ultimate concentrated loads were different in terms of capability of load bearing by the subject load transfer device(s).

TABLE 3

ANOVA showing ultimate concentrated load of
below surface LTDs and H-clips

| | | | | | |
|---|---|---|---|---|---|
| Source | DF | SS | MS | F | P |

| | | | | | |
|---|---|---|---|---|---|
| Material | 5 | 37397 | 7479 | 0.82 | 0.546 |
| Error | 35 | 320691 | 9163 | | |
| Total | 40 | 358088 | | | |

S = 95.72 R-Sq = 10.44% R-Sq(adj) = 0.00%

Individual 95% CIs For Mean Based on
Pooled StDev

| | | | | |
|---|---|---|---|---|
| Level | N | Mean | StDev | -+---------+---------+---------+-------- |
| Acetyl | 6 | 663.50 | 145.02 | (-----------*----------) |
| Aluminum | 6 | 562.67 | 52.63 | (----------*-----------) |
| H-Clips | 10 | 614.10 | 81.37 | (--------*--------) |
| HDPE | 6 | 618.00 | 70.59 | (----------*-----------) |
| Steel | 9 | 584.67 | 90.97 | (---------*--------) |
| Wood | 4 | 621.50 | 130.36 | (-------------*-------------) |
| | | | | -+---------+---------+---------+-------- |
| | | | | 490 560 630 700 |

Pooled StDev = 95.72

Our initial testing also indicated that all below surface LTDs were not significantly different than H-clips.

Thickness variations in the load transfer devices were then tested.

TABLE 4

ANOVA showing deflection under a 200 lb concentrated
load using two diferent thicknesses of below surface LTDs

| | | | | | |
|---|---|---|---|---|---|
| Source | DF | SS | MS | F | P |

| | | | | | |
|---|---|---|---|---|---|
| Thickness | 1 | 0.09264 | 0.09264 | 18.87 | 0.000 |
| Error | 29 | 0.14236 | 0.00491 | | |
| Total | 30 | 0.23500 | | | |

S +32 0.07006 R-Sq +32 39.4200 R-Sq(adj) +32 373300

Individual 95% CIs For Mean Based on
Pooled StDev

| | | | | |
|---|---|---|---|---|
| Level | N | Mean | StDev | -----+---------+---------+---------+---- |
| 0.0625 | 18 | 0.25783 | 0.05181 | (------*-----) |
| 0.1250 | 13 | 0.36862 | 0.08978 | (-------*-------) |
| | | | | -----+---------+---------+---------+---- |
| | | | | 0.250 0.300 0.350 0.400 |

Pooled StDev = 0.07006

Testing conducted on the two thicknesses of below surface LTDs indicated that the 0.0625 inch thick LTDs performed significantly better in relation to deflection under a 200 lb concentrated load than the 0.125 inch thick LTDs (See Table 4, for instance).

Ultimate concentrated load was then tested for the same devices as comparisons.

TABLE 5

ANOVA showing ultimate concentrated load of
two diferent thicknesses of below surface LTDs

| | | | | | |
|---|---|---|---|---|---|
| Source | DF | SS | MS | F | P |

| | | | | | |
|---|---|---|---|---|---|
| Thickness | 1 | 2646 | 2646 | 0.26 | 0.614 |
| Error | 29 | 295462 | 10188 | | |
| Total | 30 | 298107 | | | |

S = 100.9 R-Sq = 0.89% R-Sq(adj) = 0.00%

Individual 95% CIs For Mean Based on
Pooled StDev

| | | | | |
|---|---|---|---|---|
| Level | N | Mean | StDev | ------+---------+---------+---------+--- |
| 0.0625 | 18 | 614.7 | 101.3 | (-------------*-------------) |
| 0.1250 | 13 | 596.0 | 100.4 | (---------------*----------------) |
| | | | | ------+---------+---------+---------+--- |
| | | | | 560 595 630 665 |

Pooled StDev =100.9

Testing indicated that there are no significant differences between the two thicknesses investigated in relation to ultimate concentrated load (See Table 5).

Breaking load was then analyzed for these same devices.

TABLE 6

ANOVA showing breaking load under a concentrated load
of two diferent thicknesses of below surface LTDs

| | | | | | |
|---|---|---|---|---|---|
| Source | DF | SS | MS | F | P |

| | | | | | |
|---|---|---|---|---|---|
| Thickness | 1 | 208121 | 208121 | 28.40 | 0.000 |
| Error | 29 | 212516 | 7328 | | |
| Total | 30 | 420637 | | | |

S = 85.60 R-Sq = 49.48% R-Sq(adj) = 47.74%

Individual 95% CIs For Mean Based on
Pooled StDev

| | | | | |
|---|---|---|---|---|
| Level | N | Mean | StDev | -+---------+---------+---------+-------- |
| 0.0625 | 18 | 415.28 | 73.09 | (-----*-----) |
| 0.1250 | 13 | 249.23 | 100.70 | (------*------) |
| | | | | -+---------+---------+---------+-------- |
| | | | | 210 280 350 420 |

Pooled StDev = 85.60

Testing has indicated that the 0.0625-inch below surface LTD is significantly better in relation to breaking load than the 0.125-inch below surface LTD.

Given that concentrated load testing indicated that below surface LTDs can perform as well as H-clips, continued testing on geometries was conducted to optimize the below surface LTD. Given that it was determined that the 0.0625-inch below surface LTD performed significantly better in relation to deflection under a 200 lb concentrated load and breaking load than the 0.125-inch below surface LTDs, the 0.125-inch LTDs were dropped from further evaluation.

Further testing was conducted on the 0.0625-inch thick acetyl, aluminum, and HDPE in three sizes: 2.25″, 3.5″ and 4.5″.

TABLE 7

ANOVA showing the deflection at a 200 lb concentrated load
in relation to the three si es of below surface LTDs tested

| | | | | | |
|---|---|---|---|---|---|
| Source | DF | SS | MS | F | P |

| | | | | | |
|---|---|---|---|---|---|
| Biscuit Size | 2 | 0.01299 | 0.00649 | 2.98 | 0.081 |
| Error | 15 | 0.03264 | 0.00218 | | |
| Total | 17 | 0.04563 | | | |

S = 0.04665 R-Sq = 28.46% R-Sq(adj) = 18.92%

Individual 95% CIs For Mean Based on
Pooled StDev

| | | | | |
|---|---|---|---|---|
| Level | N | Mean | StDev | ---+---------+---------+---------+------ |
| 2.25 | 6 | 0.25083 | 0.01951 | (---------*---------) |
| 3.50 | 6 | 0.22900 | 0.03472 | (---------*---------) |
| 4.50 | 6 | 0.29367 | 0.07030 | (---------*----------) |
| | | | | ---+---------+---------+---------+------ |
| | | | | 0.200 0.240 0.280 0.320 |

Pooled StDev = 0.04665

TABLE 8

ANOVA showing the ultimate concentrated load between
three different sizes of below surface LTDs tested

| | | | | | |
|---|---|---|---|---|---|
| Source | DF | SS | MS | F | P |

| | | | | | |
|---|---|---|---|---|---|
| Biscuit Size | 2 | 16736 | 8368 | 0.80 | 0.469 |
| Error | 15 | 157778 | 10519 | | |
| Total | 17 | 174514 | | | |

S = 102.6 R-Sq = 9.59% R-Sq(adj) = 0.00%

Individual 95% CIs For Mean Based on
Pooled StDev

| | | | | |
|---|---|---|---|---|
| Level | N | Mean | StDev | -+---------+---------+---------+-------- |
| 2.25 | 6 | 571.7 | 58.2 | (-------------*-----------) |
| 3.50 | 6 | 638.3 | 75.2 | (------------*------------) |
| 4.50 | 6 | 634.2 | 150.0 | (------------*-----------) |
| | | | | -+---------+---------+---------+-------- |
| | | | | 490 560 630 700 |

Pooled StDev = 102.6

TABLE 9

ANOVA showing breaking load during concentrated load
testing using diferent size below surface LTDs

| | | | | | |
|---|---|---|---|---|---|
| Source | DF | SS | MS | F | P |

| | | | | | |
|---|---|---|---|---|---|
| Biscuit Size | 2 | 9678 | 4839 | 0.89 | 0.430 |
| Error | 15 | 81146 | 5410 | | |
| Total | 17 | 90824 | | | |

S = 73.55 R-Sq = 10.66% R-Sq(adj) = 0.00%

Individual 95% CIs For Mean Based on
Pooled StDev

| | | | | |
|---|---|---|---|---|
| Level | N | Mean | StDev | ------+---------+---------+---------+--- |
| 2.25 | 6 | 385.83 | 82.12 | (------------*------------) |
| 3.50 | 6 | 417.50 | 92.13 | (------------*-----------) |
| 4.50 | 6 | 442.50 | 31.58 | (------------*-----------) |
| | | | | ------+---------+---------+---------+--- |
| | | | | 350 400 450 500 |

Pooled StDev = 73.55

Testing indicated that there are no significant differences in relation to deflection under a 200 lb concentrated load, ultimate concentrated load, and breaking load between the different sized materials.

Although there was no significant difference between the different sized materials, there seems to be a pattern that indicates that the bigger (longer) below surface LTDs are better suited to meet the requirement of a minimum 400 lb. breaking load. Furthermore, it appeared from the analysis results that the acetyl material exhibited less propensity to break the shoulders above or below the LTD during testing, even at ultimate load, than the other materials. Thus, such a material is preferred over the others, though not required.

While the invention was described and disclosed in connection with certain preferred embodiments and practices, it is in no way intended to limit the invention to those specific embodiments, rather it is intended to cover structural equivalents and all alternative embodiments and modifications as may be defined by the scope of the appended claims and equivalence thereto.

We claim:

1. A load transfer device comprising
two faces and at least one edge
with an overall essentially symmetrically shape
which comprises a material with an MOE of about 10,000,000 psi or less
wherein a first dimension is less than a length of an edge of a panel,
wherein a second dimension is effective to hold the device within openings within edges of adjacent panels while providing a pre-determined gap between panels when panels and devices are assembled, and
wherein a third dimension is less than a thickness of a panel, and
wherein the device is capable of meeting PS-2 requirements when assembled within panels and not breaking shoulders of adjacent panels when under load.

2. A structure comprising
at least a first wood board and a second wood board connected simultaneously to at least one load transfer device;
wherein each of said first and second wood boards has a top portion and a bottom portion, and each has four peripheral edges,
wherein at least one peripheral edge of each wood board includes at least one opening therein for insertion of at least one load transfer device;
wherein said load transfer device is made of a durable material and having a first side and a second side;
wherein said side of said device is inserted within said at least one opening of said first board and said second side of said load transfer device is inserted within said at least one opening of said second board;
wherein said peripheral edges of said first and second wood boards into which said load transfer device is inserted are parallel to each other, but are not in contact with one another; and
wherein said load transfer device does not contact the top or bottom portion of said first and second wood boards.

3. The structure of claim 2 wherein said first side and said second side of said load transfer device are shaped exactly the same and exhibit the same dimensions.

4. The structure of claim 2 wherein said at least one opening within said first board and wherein said at least one opening within said second board are both of a shape and dimensions complementary to that of either of said first side or said second side of said load transfer device.

5. The structure of claim 2 wherein a plurality of openings are present within said first and second boards and a plurality of load transfer devices are inserted within at least two of said plurality of openings.

6. The structure of claim 5 wherein each of said plurality of load transfer devices is substantially identical and has a first side and said second side substantially shaped the same and exhibiting substantially the same dimensions.

7. The structure of claim 6 wherein said plurality of openings within said first and second boards are substantially identical and exhibit substantially the same shape and dimensions, and
wherein said opening shape and dimensions are complementary to that of either of said first side or said second side of said plurality of substantially identical load transfer devices.

8. The structure of claim 2 wherein said at least one load transfer device exhibits a roughened appearance on its surface.

9. The structure of claim 2 wherein said at least one load transfer device exhibits an adhesive layer on its surface.

10. The structure of claim 2 wherein said at least one load transfer device includes a pin structure to separate said first and second boards a substantially uniform distance.

11. The structure of claim 2 wherein said openings of said first and second wood boards are flared to facilitate insertion of said at least one load transfer device.
